(19) United States
(12) Patent Application Publication
(10) Pub. No.: US 2009/0257250 A1
(43) Pub. Date: Oct. 15, 2009

(54) SYNCHRONOUS RECTIFIER DC/DC CONVERTERS USING A CONTROLLED-COUPLING SENSE WINDING

(75) Inventor: Kwang-Hwa Liu, Sunnyvale, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: GREEN MARK TECHNOLOGY INC., Taipei County (TW)

(21) Appl. No.: 12/103,671

(22) Filed: Apr. 15, 2008

(51) Int. Cl. H02M 3/335

(52) U.S. Cl. 363/21.06; 363/21.01; 363/21.14

(57) ABSTRACT

A synchronous rectifier DC/DC converter is provided. The synchronous rectifier DC/DC converter includes a power transformer, a first diode, a first MOSFET, and a first controller. The power transformer includes a core, a primary winding, a secondary winding, and a sense winding. The primary winding is wrapped around the core and receives an input voltage of the synchronous rectifier DC/DC converter. The secondary winding is wrapped around the core and provides the energy of an output current of the synchronous rectifier DC/DC converter. The sense winding is wrapped around the core and provides a sense signal. The first diode is coupled to the secondary winding for rectifying the output current. The first MOSFET is coupled in parallel with the first diode. The first controller is coupled to the sense winding and the first MOSFET for turning on and turning off the first MOSFET according to the sense signal.

### BACKGROUND OF THE INVENTION

1. Field of the Invention

The present invention relates to a synchronous rectifier DC/DC converter. More particularly, the present invention relates to a synchronous rectifier DC/DC converter using a controlled-coupling sense winding.

2. Description of the Related Art

Most AC-DC switching-mode power supplies (SMPS) for computers and other digital electronic equipment use either flyback or forward converter topologies. These converters typically use PN junction diodes or Schottky diodes as their output rectifiers. The forward voltage drop Vf of a rectifier diode for power supplies ranges from 0.5V to 1.0V. Typically, the loss due to this forward voltage drop amounts to about 4% to 10% of input power.

Power metal-oxide-semiconductor field-effect transistor (power MOSFET) is a majority carrier device. Recent advancements in MOSFET technology have improved the turn-on resistance Rds(on) of a power MOSFET in a small package to less than 10 mΩ. Therefore, improving SMPS efficiency by using power MOSFET as synchronous rectifier to replace PN junction diodes or Schottky diodes is receiving more and more attention.

FIG. 1 is a schematic diagram showing a prior art forward converter using a pair of self-driven synchronous rectifiers. The synchronous rectified forward converter uses two synchronous rectifying MOSFETs, Q1 and Q2, and two rectifying diodes, a forward diode D1 and a free-wheeling diode D2. These two power MOSFETs are connected in anti-parallel with D1 and D2, respectively. Ideally, the turn-on and turn-off timing for Q1 and Q2 is synchronized to original conduction time of D1 and D2, respectively. The power transformer, Tr1, has a primary winding n1 and a secondary winding n2. The gate of Q1 is connected to the high side of n2 winding; whereas the gate of Q2 is connected to the low side of n2 winding.

In a steady-state, before the primary-side power switch Qp turns on, the output current Iout is flowing through D2 and the output inductor Lo. When Qp turns on, the input voltage Vin is applied across n1 winding of the power transformer Tr1. A voltage, Vn2, is induced across winding n2. The magnitude of Vn2 is determined according to Vn2=Vin*(n2/n1).

FIG. 2 shows the key waveforms of the FIG. 1 circuit. In FIG. 2, Vgs(Qp) is the gate-to-source voltage of Qp. Vds(Qp) is the drain-to-source voltage of Qp. Vgs1 is the gate-to-source voltage of Q1, and Vgs2 is the gate-to-source voltage of Q2. The primary power switch Qp turns on at the time T1 and turns off at T2. From T2 to T3, the drain-to-source voltage Vds of Qp ramps up to about 2 Vin, and the transformer is reset by the RCD reset circuit. At T3, the transformer is completely reset. Then, Vds settles down to the Vin level. At T4, Qp turns on again, starting a new cycle.

The gate of Q1 is connected to Vn2, therefore, its conduction time is synchronized to when Vn2 is positive, which is identical to the conduction time of Qp. On the other hand, the gate of Q2 is connected to the low side of n2 winding. Its conduction time only lasts from T2 to T3, or during the reset time of the transformer. But between T3 and T4, the voltage on n2 winding, Vn2, is essentially zero. MOSFET Q2 is turned off since the gate-to-source voltage Vgs of Q2 is zero. The free-wheeling current can only flow through D2, causing higher conduction loss.

This less than full conduction time of the free-wheeling synchronous rectifier is a major drawback in the self-driven synchronous rectifier scheme. Especially at high input voltage and light load condition, the conduction-time of Qp will be even shorter, and the reset time is shorter proportionally. This will result in a poor utilization of the free-wheeling rectifier Q2.

To remedy the less-than-full conduction time of the self-driven synchronous rectifier scheme, several synchronous rectifier control integrated circuits (ICs) are offered commercially using a predictive turn-off scheme. FIG. 3 shows such a predictive synchronous rectifier control IC.

As shown in FIG. 4, the predictive timing of the predictive synchronous rectifier controller 310 is based solely on the timing of Vn2 waveform. The turn-on of Q1 follows the rising edge of Vn2 with a slight delay, Tdel1. The turn-off of Q1 precedes the turn-off of Qp slightly, by an amount of Tdel2. Tdel1 and Tdel2 are in the order of 100 nsec to 200 nsec. This is accomplished by a predictive method. In another word, the conduction time of Q1 in a new cycle is derived from the Vn2 waveform of the preceding cycle.

Toff1(n+1)−Ton1(n+1)=Toffp(n)−Tonp(n)−Tdel1−Tdel2

Similarly, the turn-on of Q2 follows the turn-off of Qp with a slight delay Tdel1. Also, the turn-off of Q2 should precede the turn-on of Qp slightly by an amount of Tdel2. This is also accomplished by a predictive method. In another word, the conduction time of Q2 in a new cycle is derived from the Vn2 waveform of the preceding cycle as shown in FIG. 4.

Toff2(n+1)−Ton2(n+1)=Tonp(n+1)−Toffp(n)−Tdel1−Tdel2

The predictive synchronous rectifier control method works effectively for converters operating in fixed switching frequency. Unfortunately there are several situations where the predictive method will fail and result in a fatal shoot-through condition. A shoot-through condition is when the primary power switch Qp turns on before the free-wheeling rectifier Q2 turns off, creating a short circuit condition. One situation where Qp turns on unexpectedly against the predictive scheme is the converter operates in variable switching frequency, such as quasi-resonant converters, or converters operating with spread-spectrum switching frequency. Another situation is the forward converter has a green mode where several switching cycles are skipped in a light load condition.

The shoot-through condition can be seen from FIG. 5. In FIG. 5, Vgp is the gate-to-source voltage of the primary power switch Qp. Assume the forward converter operates at a constant frequency up to cycle (n+1). However, in cycle (n+2), Qp turn-on pulse comes in sooner than in the preceding cycles. Here, Qp turns on at T5 before Q2 turns off at T6, which is based on the predictive timing according to cycle (n+1). Since Q2 is still in its on state, Vn2 is effectively shorted to ground by Q2. Between T5 and T6, a large current quickly builds up through Q2 and D1. Worse, with Q2 shorting Vn2 to ground, it is difficult for the control circuit to detect the short circuit situation, since Vn2 may be only several tens of milli-volts, and its waveform is very noisy during the shoot-through transient period.

As shown in FIG. 5, during the shoot-through transient, the surge current through Q2 is only limited by the leakage inductance of n2 winding. Very often, the shoot-through current is exceedingly high and can easily destroy the power MOSFETs.

To prevent the shoot-through current from damaging the synchronous rectifiers, it is necessary to detect the turn-on timing of Qp in order to turn off Q2 quickly. The use of a separate pulse transformer as shown in FIG. 6, is a widely adopted approach to transmit Qp's turn-on timing to the synchronous rectifier control circuits 610 and 620. Since the pulse transformer, Tr2, is physically separated from the power transformer, Tr1, it can always transmit clean and solid turn-on and turn-off signals of Qp, Vpt, to the synchronous rectifier Q2 controller 620. The controller 620 turns off Q2 according to either one of the following conditions: (a) predictive Q2 conduction time based on the previous switching cycle or (b) Qp's turn-on transient, that is, the rising edge of Vpt.

Please refer to FIG. 6 and FIG. 7. The synchronous rectifier controller can monitor the turn-on of Qp by the rising edge of Vpt. Again, Qp turns on at T5 before Q2 turns off at T6. A shoot-through current quickly builds up via Q2 and D1. However, as the synchronous rectifier controller detects the rising edge of Vpt at T5, it can immediately shut down Q2. At T6, Q2 turns off. At T7, the shoot-through current drops to zero. Compared with the situation in FIG. 5, the current spike is much reduced when Q2 can be turned off as soon as the controller detects Qp has been turned on.

The use of a pulse transformer to transmit the switching timing of Qp is very effective. However, the pulse transformer is another transformer which has to be included in the converter circuit and is also subject to the 4000V isolation requirement for the compliance with international safety standards backed by prestigious organizations such as Underwriters Laboratories (UL), Canadian Standards Association (CSA), and International Electrotechnical Commission (IEC). The main drawback of this pulse transformer approach is its bulky size and additional cost.

Therefore there is a need to provide a reliable and noise-free switching signal of Qp for synchronous rectified converters without the need for a separate and costly pulse transformer.

### SUMMARY OF THE INVENTION

Accordingly, the present invention is directed to a synchronous rectifier DC/DC converter. This synchronous rectifier DC/DC converter features a simple controlled-coupling sense winding on a power transformer. The sense winding provides a reliable and noise-free switching signal in the synchronous rectifier DC/DC converter to limit the current spike in a shoot-through condition.

According to an embodiment of the present invention, a synchronous rectifier DC/DC converter is provided. The synchronous rectifier DC/DC converter includes a power transformer, a first diode, a first MOSFET, and a first controller. The power transformer includes a core, a primary winding, a secondary winding, and a sense winding. The primary winding is wrapped around the core and receives an input voltage of the synchronous rectifier DC/DC converter. The secondary winding is wrapped around the core and provides the energy of an output current of the synchronous rectifier DC/DC converter. The sense winding is wrapped around the core and provides a sense signal. The first diode is coupled to the secondary winding for rectifying the output current. The first MOSFET is coupled in parallel with the first diode. The first controller is coupled to the sense winding and the first MOSFET for turning on and turning off the first MOSFET according to the sense signal.

In an embodiment of the present invention, the primary winding is between the secondary winding and the sense winding. The winding structure of the power transformer has two variations. In the first variation, the primary winding is wrapped around the secondary winding and the sense winding is wrapped around the primary winding. In the second variation, the primary winding is wrapped around the sense winding and the secondary winding is wrapped around the primary winding.

In another embodiment of the present invention, the sense winding is between the primary winding and the secondary winding. The winding structure of the power transformer has two variations. In the first variation, the sense winding is wrapped around the primary winding and the secondary winding is wrapped around the sense winding. In the second variation, the sense winding is wrapped around the secondary winding and the primary winding is wrapped around the sense winding.

In another embodiment of the present invention, the first controller turns on the first MOSFET in response to a falling edge of the sense signal.

In another embodiment of the present invention, the first controller turns off the first MOSFET at the earlier one of a first moment and a second moment. The first moment is predicted according to a rising edge in a first cycle of the sense signal. The second moment is determined according to a rising edge in a second cycle of the sense signal. The first cycle is previous to the second cycle.

In another embodiment of the present invention, the synchronous rectifier DC/DC converter is a forward converter, including a second diode, a second MOSFET; and a second controller. The second diode is coupled to the secondary winding and the first diode for rectifying the output current. The second MOSFET is coupled in parallel with the second diode. The second controller is coupled to the sense winding and the second MOSFET for turning on and turning off the second MOSFET according to the sense signal.

In another embodiment of the present invention, the second controller turns on the second MOSFET in response to a rising edge in a first cycle of the sense signal. The second controller turns off the second MOSFET at a moment predicted according to a falling edge in a second cycle of the sense signal. The second cycle is previous to the first cycle.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a conventional forward converter with self-driven synchronous rectifiers.

FIG. 2 is a schematic diagram showing some important signal waveforms in the conventional forward converter in FIG. 1.

FIG. 3 is a schematic diagram showing a conventional forward converter with a predictive synchronous rectifier control.

FIG. 4 is a schematic diagram showing some important signal waveforms in the conventional forward converter in FIG. 3.

FIG. 5 is a schematic diagram showing a shoot-through condition in the conventional forward converter in FIG. 3.

FIG. 6 is a schematic diagram showing a conventional synchronous rectified forward converter with a pulse transformer.

FIG. 7 is a schematic diagram showing some important signal waveforms in the conventional forward converter in FIG. 6.

FIG. 8 is a schematic diagram showing a synchronous rectified forward converter with a sense winding on a power transformer according to an embodiment of the present invention.

FIG. 9 is a schematic diagram showing some important signal waveforms in the forward converter in FIG. 8.

FIG. 10A is a schematic diagram showing a winding structure of a power transformer according to an embodiment of the present invention.

FIG. 10B is a schematic diagram showing an equivalent circuit model of FIG. 10A.

FIG. 10C shows key signal waveforms of the circuit in FIG. 10B in the shoot-through condition.

FIG. 11A is a schematic diagram showing an improved winding structure according to an embodiment of the present invention.

FIG. 11B is a schematic diagram showing an equivalent circuit model of FIG. 11A.

FIG. 11C shows key signal waveforms of the circuit in FIG. 11B in the shoot-through condition.

FIG. 12A is a schematic diagram showing another improved winding structure according to an embodiment of the present invention.

FIG. 12B is a schematic diagram showing an equivalent circuit model of FIG. 12A.

FIG. 12C shows key signal waveforms of the circuit in FIG. 12B in the shoot-through condition.

FIG. 13 is a schematic diagram showing a synchronous rectified flyback converter in continuous-conduction mode according to an embodiment of the present invention.

FIG. 14 shows key signal waveforms of the flyback converter in FIG. 13.

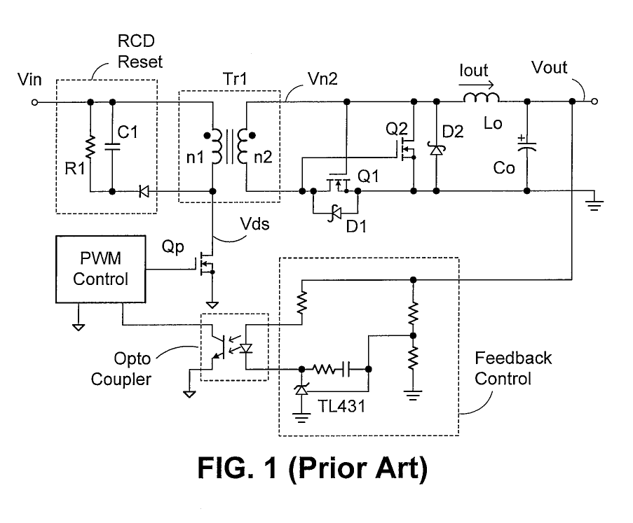

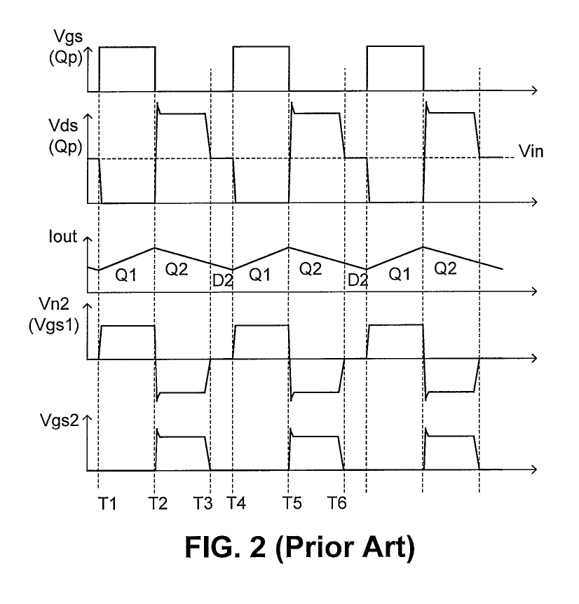

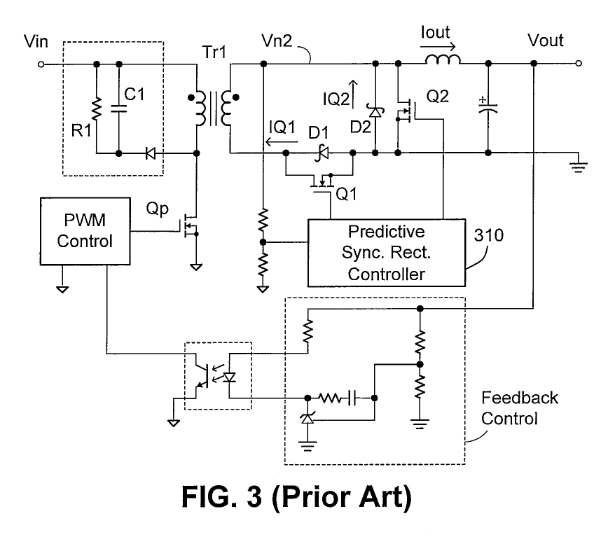

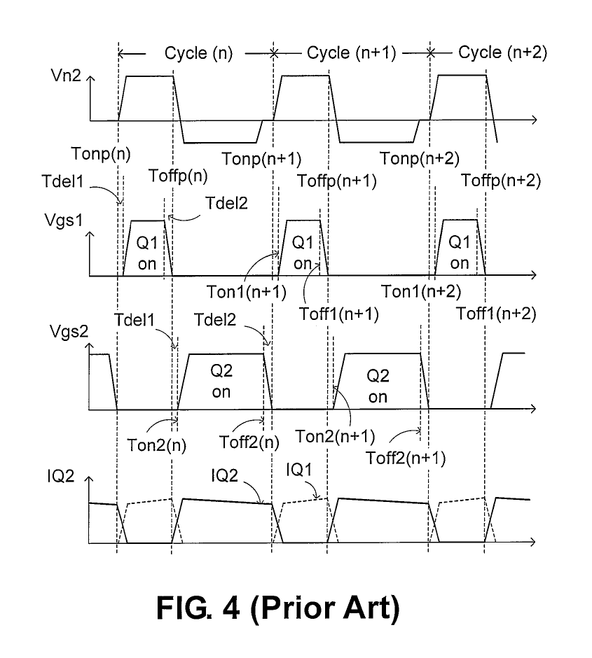

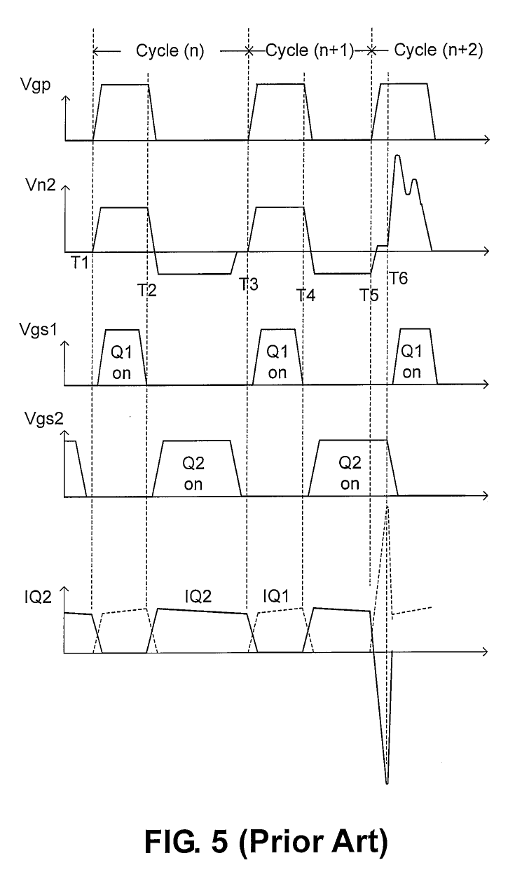

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

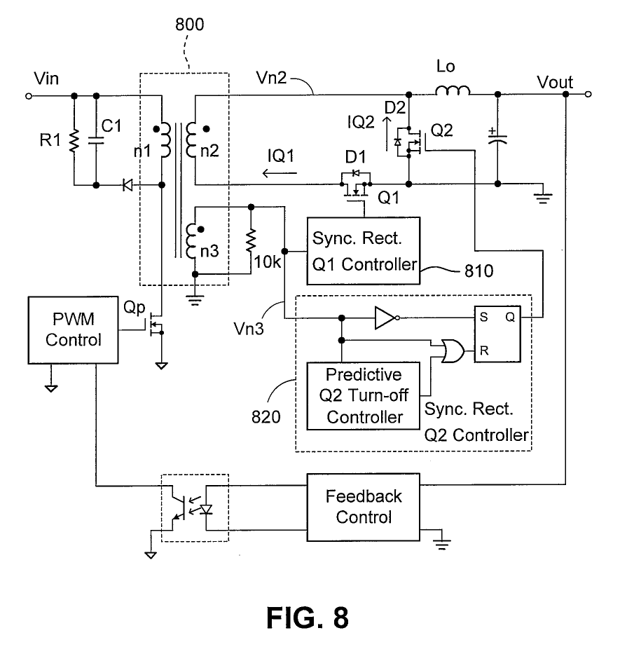

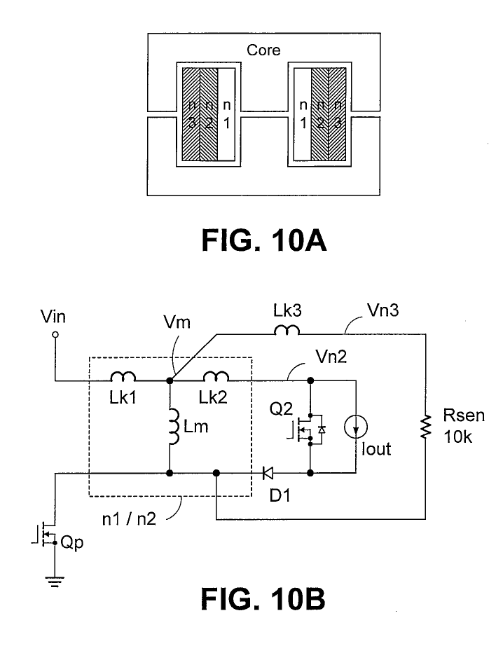

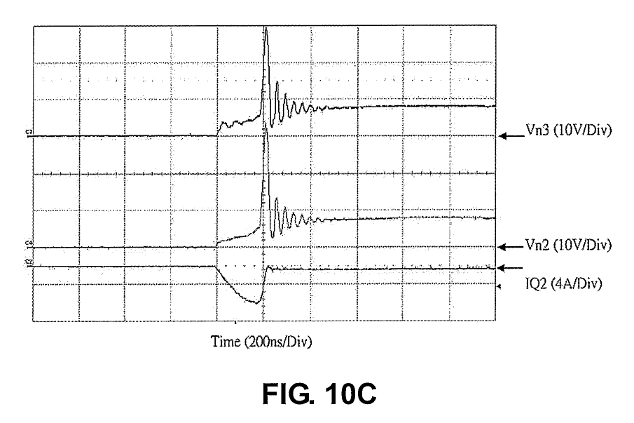

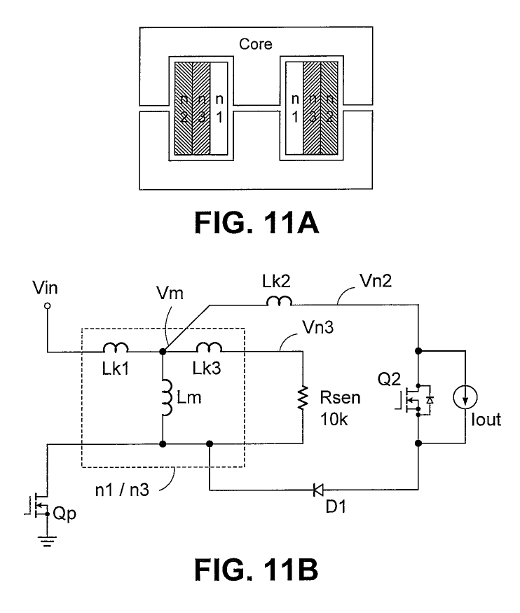

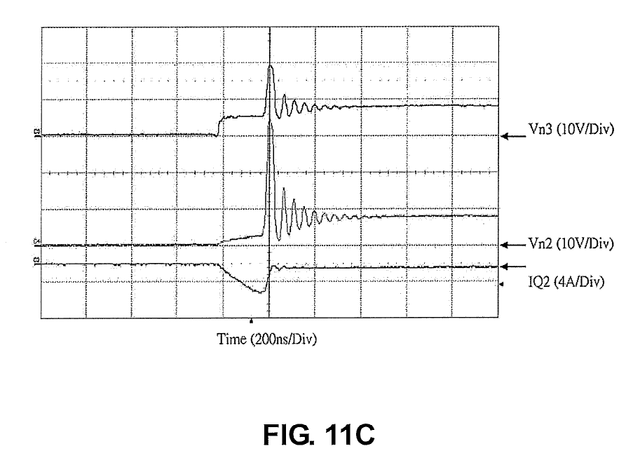

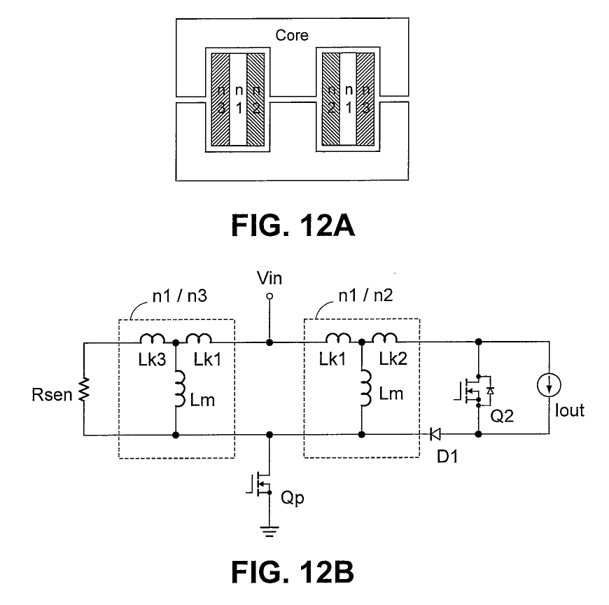

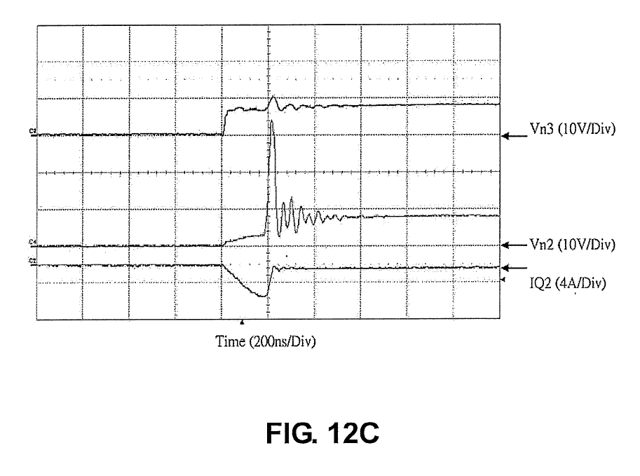

Please refer to FIG. 8. FIG. 8 is a schematic diagram showing a synchronous rectifier DC/DC converter according to an embodiment of the present invention. The synchronous rectifier DC/DC converter is a forward converter which includes a power transformer 800, diodes D1 and D2, MOSFETs Q1 and Q2, a Q1 controller 810, a Q2 controller 820, and some other components. The power transformer 800 may be designed as shown in FIG. 10A, FIG. 11A, or FIG. 12A. The power transformer 800 includes a core, a primary winding n1, a secondary winding n2, and a sense winding n3. The primary winding n1 is wrapped around the core and receives an input voltage Vin of the synchronous rectifier DC/DC converter. The secondary winding n2 is wrapped around the core and provides the energy of an output current Iout of the synchronous rectifier DC/DC converter. The sense winding n3 is wrapped around the core and provides a sense signal Vn3, which is a voltage signal.

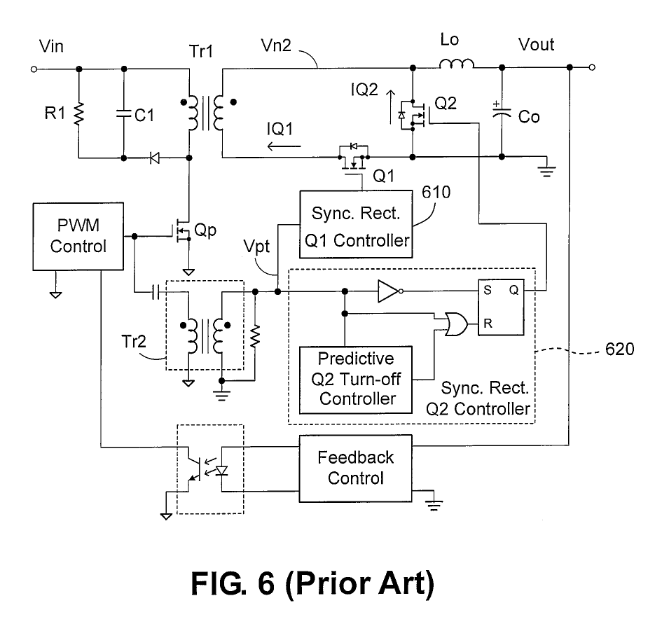

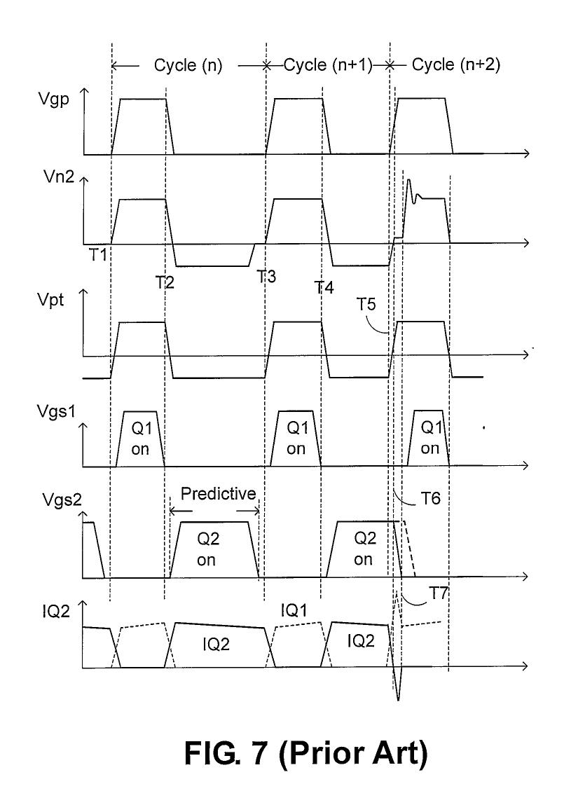

The diode D1 is coupled to the secondary winding n2 and the diode D2 for rectifying the output current Iout. The MOSFET Q1 is coupled in parallel with the diode D1. The Q1 controller is coupled to the sense winding n3 and the MOSFET Q1 for turning on and turning off the MOSFET Q1 according to the sense signal Vn3. The diode D2 is coupled to the secondary winding n2 for rectifying the output current Iout. The MOSFET Q2 is coupled in parallel with the diode D2. The Q2 controller is coupled to the sense winding n3 and the MOSFET Q2 for turning on and turning off the MOSFET Q2 according to the sense signal Vn3. The other components of the synchronous rectifier DC/DC converter in FIG. 8 are similar to their counterparts in FIG. 6.

As soon as Qp turns on, the sense signal Vn3 is induced via the sense winding

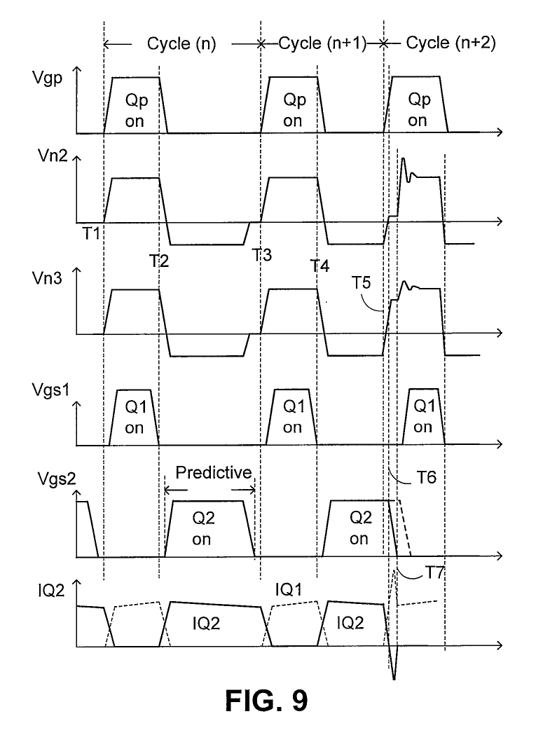

n3. The sense signal Vn3 is a better replacement of the signal Vpt in FIG. 6. Now please refer to FIG. 8 and FIG. 9. FIG. 9 shows the key waveforms of the synchronous rectifier DC/DC converter in FIG. 8. The function of the Q1 controller 810 in FIG. 8 is the same as that of the Q1 controller 610 in FIG. 6 except that the Q1 controller 810 turns on and turns off Q1 according to the sense signal Vn3 instead of Vpt. Similarly, the function of the Q2 controller 820 in FIG. 8 is the same as that of the Q2 controller 620 in FIG. 6 except that the Q2 controller 820 turns on and turns off Q2 according to the sense signal Vn3 instead of Vpt.

As shown in FIG. 9, the predictive timing of the synchronous rectifier Q1 controller 810 is based solely on the sense signal Vn3. The turn-on of Q1 follows the rising edge in the current cycle of Vn3 with a slight predetermined or propagation delay. The turn-off of Q1 precedes the turn-off of Qp slightly by a predetermined amount of time. The moment of turning off Q1 is predicted according to the falling edge of the Vn3 waveform in the preceding cycle.

The predictive timing of the synchronous rectifier Q2 controller 820 is also based solely on the sense signal Vn3. The turn-on of Q2 follows the falling edge of the sense signal Vn3 with a slight predetermined or propagation delay. The Q2 controller 820 turns off Q2 at the earlier one of a first moment and a second moment. The first moment (T7 in FIG. 9) is predicted according to the rising edge in the previous cycle of the sense signal Vn3. The second moment (T6 in FIG. 9) follows the rising edge in the current cycle of the sense signal Vn3 with a slight predetermined or propagation delay.

When the switching cycle of Qp remains constant, the Q2 controller 820 turns off Q2 at the predicted first moment. When the switching cycle of Qp changes and Qp turns on before Q2 turns off, the Q2 controller 820 detects the rising edge of the sense signal Vn3 and turns off the MOSFET Q2 in response. By this mechanism, the MOSFET Q2 can be turned off immediately to prevent the damage caused by the shoot-through condition.

Ideally, the sense winding n3 provides a clean and reliable waveform Vn3 for the Q2 controller, even during the shoot-through condition between the time T5 and T7. As long as the turn-on timing of the primary switch Qp is correctly provided by the sense winding n3, the Q2 controller can turn off the MOSFET Q2 at the onset of the shoot-through phenomenon. Therefore a reliable sense signal Vn3 keeps the shoot-through current spike below a safe level.

In order to achieve a reliable and noise-free sense signal Vn3 from the sense winding n3, a good understanding of the power transformer winding structure, the coupling coefficient between windings, and the interaction between the primary-side circuit and the secondary-side circuit during a shoot-through situation is required.

In essence, the key to achieve a reliable and noise-free sense signal Vn3 is to increase the coupling between the sense winding n3 and the primary winding n1; and at the same time, to reduce the coupling between the sense winding n3 and the secondary winding n2. The different results can be seen in the following three variations of the winding structure of the power transformer 800.

FIG. 10A is a cross section view of the core and the windings of the power transformer 800. FIG. 10A shows the winding structure with an improper sense winding placement. The primary winding, n1, is placed at the innermost layer; the secondary winding, n2, is placed in the middle; and the sense winding, n3, is placed at the outermost layer. This winding structure favors the coupling between windings n1 and n2; whereas the coupling between windings n1 and n3 is mediocre due to the shielding effect of the n2 winding.

FIG. 10B shows the equivalent circuit model for the power transformer 800 where the primary switch Qp turns on into a shoot-through condition (both primary switch Qp and MOSFET Q2 are still on). Lm is the magnetizing inductance of the power transformer, 800. Lk1 is the leakage inductance of the primary winding n1, Lk2 is the leakage inductance of the secondary winding n2, and Lk3 is the leakage inductance of the sense winding n3. Assume the magnetizing inductance Lm is 100 uH. Lk1 and Lk2 are both 1 uH. But Lk3 is higher (assume it is 2 uH) since winding n3 is shielded away from the primary winding n1 by the secondary winding n2. The resistor Rsen represents the equivalent resistance in the real circuit.

In a shoot-through condition, the voltage across the magnetizing inductance Lm, Vm, is about one half of Vin, since Lm is much greater than Lk2. Vn2 is essentially 0. But Vn3, with the time constant of less than 1.0 ns (Lk3/Rsen=2 uH/10 kOhm=0.2 nsec), is an instantaneous replica of the Vm. FIG. 10C is a diagram showing signal waveforms of Vn2, Vn3, and IQ2 measured from an actual implementation of the power transformer 800. The actual Vn3 waveform shows there is a significant ringing noise during the shoot-through transient. Therefore, the actual sense signal Vn3 is unsuitable for indicating the turn-on timing of Qp.

FIG. 11A shows an improved winding structure of the power transformer 800. The primary winding n1 is placed at the innermost layer, the sense winding n3 is placed in the middle, and the secondary winding n2 is placed at the outermost layer. This winding structure favors the coupling between windings n1 and n3; whereas the coupling between windings n1 and n2 is mediocre due to the shielding effect of the sense winding n3.

FIG. 11B shows the equivalent circuit model for the power transformer 800 where the primary switch Qp turns on into a shoot-through condition (both primary switch Qp and MOSFET Q2 are still on). Here the Lk2 is assumed to be 2 uH. Lk3 is 1 uH. In a shoot-through condition, Vm will essentially assume two-thirds of Vin.

FIG. 11C shows the actual waveform of Vn3 is very close to the prediction based on the transformer model in FIG. 11B. At the onset of the shoot-through period, Vn3 jumps to ⅔Vin quickly. While the Vn2 waveform is essentially similar to that in FIG. 10C, Vn3 waveform in FIG. 11C is much less noisy. Vn3 spike of FIG. 11C is about one half of that in FIG. 10C.

An alternative embodiment of FIG. 11A is with n2 winding placed at the innermost layer, and n1 winding placed at the outermost layer. The equivalent circuit model is the same as that in FIG. 11B.

FIG. 12A shows another improved winding structure of the power transformer 800. The secondary winding n2 is placed at the innermost layer, the primary winding n1 is placed in the middle, and the sense winding n3 is placed at the outermost layer. This winding structure has good coupling between windings n1 and n2, as well as between windings n1 and n3; whereas the coupling between windings n2 and n3 is mediocre due to the shielding effect of the n1 winding.

FIG. 12B shows the equivalent circuit model for the power transformer 800 where the primary switch Qp turns on into a shoot-through condition (both primary switch Qp and MOSFET Q2 are still on). Since n2 and n3 windings are on different sides of n1 winding, we can treat their coupling like two independent transformers. Here both Lk2 and Lk3 are assumed to be 1 uH.

FIG. 12C shows the actual waveform of Vn3 is very close to the prediction based on the transformer model in FIG. 12B. At the onset of the shoot-through period, Vn3 jumps to Vin quickly. While Vn2 waveform is essentially similar to that in FIG. 10C, Vn3 waveform in FIG. 12C is essentially a clean step waveform without the spike and noise of Vn2. Therefore, the winging structure in FIG. 12A give the best result for the Vn3 waveform.

An alternative embodiment of FIG. 12A is with n3 winding placed at the innermost layer, and n2 winding placed at the outermost layer. The equivalent circuit model is the same as that in FIG. 12B.

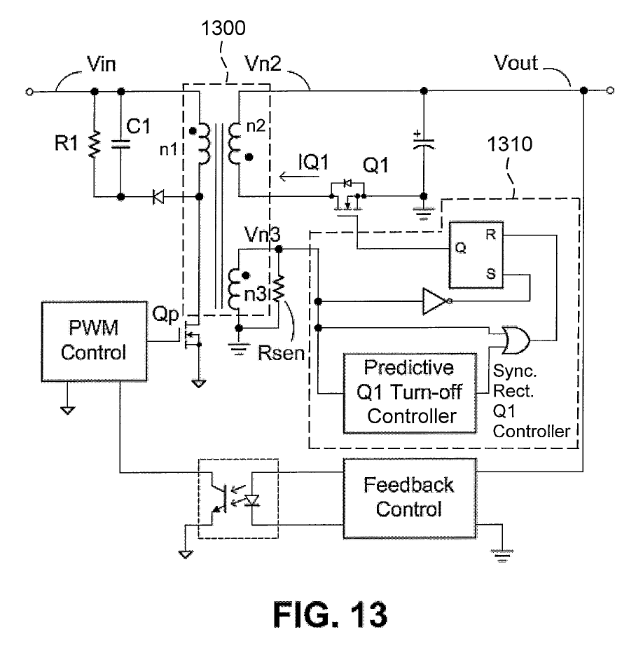

This controlled-coupling sense winding scheme can be applied to forward converter or its variation topologies such as half-bridge and full-bridge converters. It can also be applied to flyback converters operating in continuous-conduction mode, as shown in FIG. 13. The power transformer 1300 in FIG. 13 is similar to the power transformer 800 in FIG. 8 and the Q1 controller 1310 in FIG. 13 is similar to the Q2 controller 820 in FIG. 8.

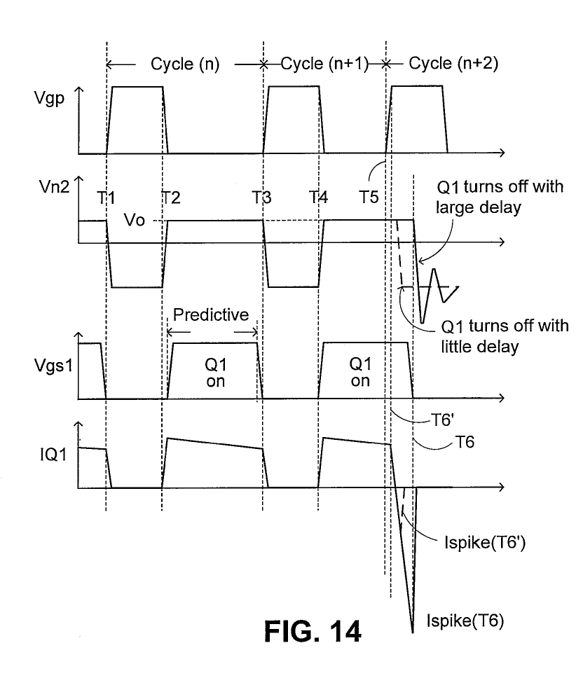

FIG. 14 shows when the primary switch Qp in FIG. 13 turns on (unpredictably at the time T5) before the MOSFET Q1 turns off (at T6), there will be a shoot-through condition. The current spike is severe and could be fatal to the MOSFET Q1.

However, with the sense winding, n3, the Q1 controller 1310 can detect the turn-on of Qp at T5 through the sense signal Vn3, and turns off the MOSFET Q1 immediately at T6′. This greatly reduces the current spike as shown in the IQ1 waveform in FIG. 14.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A synchronous rectifier DC/DC converter, comprising:
a power transformer, comprising:
a core;
a primary winding wrapped around the core and receiving an input voltage of the synchronous rectifier DC/DC converter;
a secondary winding wrapped around the core and providing energy of an output current of the synchronous rectifier DC/DC converter; and
a sense winding wrapped around the core and providing a sense signal;
a first diode coupled to the secondary winding for rectifying the output current;
a first MOSFET coupled in parallel with the first diode; and
a first controller coupled to the sense winding and the first MOSFET for turning on and turning off the first MOSFET according to the sense signal.

2. The synchronous rectifier DC/DC converter of claim 1, wherein the primary winding is between the secondary winding and the sense winding.

3. The synchronous rectifier DC/DC converter of claim 2, wherein the primary winding is wrapped around the secondary winding and the sense winding is wrapped around the primary winding.

4. The synchronous rectifier DC/DC converter of claim 2, wherein the primary winding is wrapped around the sense winding and the secondary winding is wrapped around the primary winding.

5. The synchronous rectifier DC/DC converter of claim 1, wherein the sense winding is between the primary winding and the secondary winding.

6. The synchronous rectifier DC/DC converter of claim 5, wherein the sense winding is wrapped around the primary winding and the secondary winding is wrapped around the sense winding.

7. The synchronous rectifier DC/DC converter of claim 5, wherein the sense winding is wrapped around the secondary winding and the primary winding is wrapped around the sense winding.

8. The synchronous rectifier DC/DC converter of claim 1, wherein the sense signal is a voltage signal.

9. The synchronous rectifier DC/DC converter of claim 1, wherein the first controller turns on the first MOSFET in response to a falling edge of the sense signal.

10. The synchronous rectifier DC/DC converter of claim 1, wherein the first controller turns off the first MOSFET at the earlier one of a first moment and a second moment, the first moment is predicted according to a rising edge in a first cycle of the sense signal and the second moment is determined according to a rising edge in a second cycle of the sense signal, the first cycle is previous to the second cycle.

11. The synchronous rectifier DC/DC converter of claim 1, wherein the synchronous rectifier DC/DC converter is a forward converter.

12. The synchronous rectifier DC/DC converter of claim 11, further comprising:
a second diode coupled to the secondary winding and the first diode for rectifying the output current;
a second MOSFET coupled in parallel with the second diode; and
a second controller coupled to the sense winding and the second MOSFET for turning on and turning off the second MOSFET according to the sense signal.

13. The synchronous rectifier DC/DC converter of claim 12, wherein the second controller turns on the second MOSFET in response to a rising edge in a first cycle of the sense signal, the second controller turns off the second MOSFET at a moment predicted according to a falling edge in a second cycle of the sense signal, the second cycle is previous to the first cycle.

14. The synchronous rectifier DC/DC converter of claim 1, wherein the synchronous rectifier DC/DC converter is a half-bridge converter.

15. The synchronous rectifier DC/DC converter of claim 1, wherein the synchronous rectifier DC/DC converter is a full-bridge converter.

16. The synchronous rectifier DC/DC converter of claim 1, wherein the synchronous rectifier DC/DC converter is a flyback converter.
